(19) United States
(12) Patent Application Publication
(10) Pub. No.: US 2011/0200850 A1
(43) Pub. Date: Aug. 18, 2011

(54) HYBRID SYSTEM AND METHOD FOR SUPPLYING AIR TO A HYBRID SYSTEM

(75) Inventors: Ulrich Gottwick, Stuttgart (DE); Nils Kaiser, Bietigheim-Bissingen (DE)

(73) Assignee: ROBERT BOSCH GMBH, Stuttgart (DE)

(21) Appl. No.: 13/028,343

(22) Filed: Feb. 16, 2011

(30) Foreign Application Priority Data
Feb. 16, 2010 (DE) 10 2010 001 966.6

(51) Int. Cl. H01M 16/00; H01M 12/06; H01M 8/04; H01M 8/06

(52) U.S. Cl. 429/9; 429/407; 429/444; 429/413

(57) ABSTRACT

A hybrid system (1) having at least one metal/air battery (10) and at least one fuel cell stack (20), in which the hybrid system (1) has an air supply device (2) with an air feed line (3), an intake device (5) and a compressor (4) for compressing the air stream in the air feed line (3), the air supply device (2) being designed both for supplying air to the at least one metal/air battery (10) and for supplying air to the at least one fuel cell stack (20) with an air stream subjected to excess pressure. A method for supplying air to a hybrid system (1) of this kind having at least one metal/air battery (10) and at least one fuel cell stack (20).

### BACKGROUND OF THE INVENTION

The invention relates to a hybrid system having at least one metal/air battery and at least one fuel cell stack. The invention furthermore relates to a method for supplying air to a hybrid system having at least one metal/air battery and at least one fuel cell stack.

Hybrid systems, also referred to as hybrid drives, combine different energy sources or energy converters with one another. Thus, hybrid vehicles have, for example, two different energy sources or energy converters for the drive. For a hybrid vehicle of the fuel cell type, a fuel cell stack and at least one battery are used.

Fuel cells are used, in particular, to generate electric current from hydrogen. A fuel cell is a special type of electrochemical element. A fuel cell stack has a multiplicity of fuel cells connected in series. The individual fuel cells are constructed as follows: between two electrodes, i.e. the anode and the cathode, there is an electrolyte, which allows ion or proton exchange.

A metal/air battery is what is referred to as a primary battery, which allows a high energy density. A metal/air battery can be a zinc/air battery, a lithium/air battery, a lead/air battery, a magnesium/air battery or an aluminum/air battery, for example. In a metal/air battery, the anode is composed of metal, which is immersed in an electrolyte, such as a potassium hydroxide solution. The cathode of a metal/air battery generally forms an air-permeable and electrically conductive layer of carbon, which ensures that air or atmospheric oxygen comes into contact with the electrolyte. As a result, the metal is oxidized and an electric voltage is set up between the anode and the cathode. In order to obtain a closed materials cycle, the metal oxide formed can be split again electrolytically to recover the metal. Thus, the energy in metal/air batteries is held in the metals used, such as zinc, lithium, lead, aluminum or magnesium, which, with their high energy densities, are very efficient means of storing energy. However, the diffusion of the air into the body of the battery limits the power that can be taken from the battery.

Fuel cell stacks currently have a higher efficiency if they are operated at excess pressure relative to atmosphere. However, the mechanical stability of the diaphragm between the anode space and the cathode space tolerates pressure differences to only a limited extent. The fuel cell stack is therefore generally subjected to pressure both on the anode side, i.e. on the hydrogen side, and on the cathode side, i.e. on the air side.

In hybrid systems of this kind, which have a metal/air battery and a fuel cell stack, the metal/air battery and the fuel cell stack are each supplied independently with air, in particular with pressurized air.

### SUMMARY OF THE INVENTION

It is the object of the invention to improve the air supply for a hybrid system with at least one metal/air battery and at least one fuel cell stack and to make such a hybrid system more compact. Moreover, the intention is to improve the efficiency of the hybrid system, in particular of the metal/air battery and to provide better protection for the metal/air battery by means of an improved air supply.

These objects are achieved, according to the invention, by a hybrid system having at least one metal/air battery and at least one fuel cell stack wherein the hybrid system has an air supply device with an air feed line, an intake device and a compressor for compressing the air stream in the air feed line, the air supply device supplying air to the at least one metal/air battery and supplying air to the at least one fuel cell stack with an air stream subjected to excess pressure and by a method for supplying air to a hybrid system having at least one metal/air battery and at least one fuel cell stack wherein air for supplying air to the at least one metal/air battery and to the at least one fuel cell stack is sucked into an air feed line of a common air supply device; the air stream in the air feed line is compressed by a compressor ; the air stream is divided into a first air stream and into a second air stream; and the first air stream is fed to the at least one metal/air battery and the second air stream is fed to the at least one fuel cell stack. Further features and details of the invention will become apparent from the claims, the description and the drawings. In this context, features and details which are described in connection with the hybrid system according to the invention also apply, of course, in connection with the method according to the invention and vice versa, and there is therefore always a mutual reference with respect to the disclosure of the individual aspects of the invention.

According to the first aspect of the invention, the object is achieved by a hybrid system having at least one metal/air battery and at least one fuel cell stack, in which the hybrid system has an air supply device with an air feed line, an intake device and a compressor for compressing the air stream in the air feed line, the air supply device being designed both for supplying air to the at least one metal/air battery and for supplying air to the at least one fuel cell stack with an air stream subjected to excess pressure.

By means of a hybrid system designed in this way, the at least one metal/air battery and the at least one fuel cell stack can be provided with a common air supply, thus making the hybrid system more compact. By virtue of the common compressed air supply, i.e. a common air supply device with a common intake device, a single air feed line and a common compressor, it is possible to save on components as compared with a dedicated compressed air supply for the metal/air battery and a dedicated compressed air supply for the fuel cell stack. As a result, it is possible to make the hybrid system not only more compact but also less expensive.

It is advantageous if the hybrid system has a metal/air battery and a fuel cell stack formed by a multiplicity of individual fuel cells. The air supply device of the hybrid system has an intake device and an air feed line. Via the intake device, air, in particular ambient air, is drawn or sucked into the air feed line. The intake device, such as a fan, is provided, preferably in the air feed line, for the purpose of drawing in the air. This intake device is preferably mounted directly at the inlet of the air feed line of the air supply device of the hybrid system. The air supply device furthermore has a compressor for compressing the air stream in the air feed line. The compressor is a fluid energy machine by means of which the air drawn in can be compressed. That is to say the compressor ensures that the pressure of the air stream drawn in is increased. It is advantageous if the compressor is designed in such a way that it can increase the pressure of the air drawn in to 1.1-4 bar, in particular to 3 bar.

The common air supply device is used to supply air to the at least one metal/air battery and to supply air to the at least one fuel cell stack. Both energy sources or energy converters can be supplied with an air stream subjected to excess pressure via just one intake device, one air feed line and one compressor.

The air stream drawn into the single air feed line is compressed, and the compressed air stream is fed, on the one hand, to the cathode side of the fuel cell stack and, on the other hand, to the cathode, i.e. to the air electrode, of the metal/air battery. For this purpose, the air feed line divides into two air streams after compression.

The compressor is preferably designed as a turbocompressor. Turbocompressors are advantageous especially at high volume flows, in this case air flows, and low compression pressures. However, other types of compressor can also be used.

According to a preferred development of the invention, provision can be made in the hybrid system for at least one cooling device for cooling the compressed air stream downstream of the compressor to be arranged in or on the air feed line. As a result of the compression of the air stream by the compressor, the air is heated. The greater the compression of the air, the hotter it becomes. The cooling device preferably has one or more heat exchangers, in particular air heat exchangers. The cooling device is arranged on the air feed line in such a way that it can cool the compressed air stream. During compression of the air stream in the air feed line to up to three bar, the air can heat up to as much as 150° C. The cooling device cools the air stream back to below 100° C., in particular to a temperature of between 40° C. and 70° C.

Preference is given to a hybrid system in which division of the air feed line into two air feed line branches is provided in or after the cooling device, in particular the heat exchanger, a first air feed line branch being designed to feed air to the at least one metal/air battery, and a second air feed line branch being designed to feed air to the at least one fuel cell stack. Thus, the air stream can be divided into two air feed line branches in the cooling device itself, for example, so that a first air stream leaving the cooling device is directed to the metal/air battery, and a second air stream leaving the cooling device is directed to the fuel cell stack. In an alternative variant embodiment of the hybrid system, the division of the air stream into two air feed line branches can take place only after the cooling device.

If it is necessary that the metal/air battery and the fuel cell stack should be pressurized with air at different temperatures, provision can be made to arrange a further cooling device, in particular a further heat exchanger, in one of the two air feed line branches. Since fuel cell stacks are often subject to a higher air temperature than metal/air batteries, a further cooling device is preferably provided in the first air feed line branch, i.e. in the air feed to the at least one metal/air battery. By means of a first cooling device, the compressed air stream in the air feed line can be cooled to a temperature of from 60° C. to 70° C., for example. It is advantageous if the fuel cell stack is supplied with a compressed air stream at a temperature of from 60° C. to 70° C. Metal/air batteries are preferably supplied with compressed air at an air temperature of from 40° C. to 50° C. Providing a second cooling device, in particular a second heat exchanger, in the first air feed line branch, which leads to the metal/air battery, is therefore an advantageous possibility.

According to another preferred development of the invention, provision can be made in the hybrid system for a throttle element for reducing the pressure of the air stream to be provided in the first air feed line branch and/or in the second air feed line branch. A throttle element should be provided in at least one of the two air feed line branches if the metal/air battery and the fuel cell stack are not designed for an air stream at the same pressure level. If the metal/air battery is designed for a lower pressure level than the fuel cell stack, a throttle element is provided in the direction of the metal/air battery, i.e. in the first air feed line branch. Otherwise, if the fuel cell stack is designed for a lower pressure level than the metal/air battery, a throttle element is provided in the direction of the fuel cell stack, i.e. in the second air feed line branch. If the pressure levels of the energy sources or energy converters vary, provision can be made to arrange a throttle element in both directions, i.e. in both air feed line branches. This enables the pressures of the air streams to be varied selectively. The throttle element can be a throttle flap, a nozzle or a valve, for example.

Preference is furthermore given to a hybrid system in which an air dehumidifier is provided in the first air feed line branch and/or an air humidifier is provided in the second air feed line branch. Depending on the construction of the at least one fuel cell stack, it may be necessary to humidify the air fed to the fuel cell stack. In this case, an air humidifier is provided in the second air feed line branch, i.e. in the air stream feed to the fuel cell stack. The air humidifier humidifies the compressed air fed to the fuel cell stack. If the metal/air battery cannot tolerate any humidity in the air, for example, an air dehumidifier is provided in the first air feed line branch, i.e. in the air stream feed to the metal/air battery. The air dehumidifier removes moisture from the air stream and, in particular, retains water vapor. Provision can be made to provide both an air humidifier in the direction of the fuel cell stack and an air dehumidifier in the direction of the metal/air battery.

Particular preference is given to a hybrid system in which the air dehumidifier in the first air feed line branch is connected to the second air feed line branch or to the air humidifier in the second air feed line branch for the purpose of humidifying the air stream in the second air feed line branch. Here, the word “connected” means that the air dehumidifier can direct moisture or water vapor via a line to the second air feed line branch or to the air humidifier in the second air feed line branch. A throttle element or a compressor can be provided in said line if the metal/air battery and the fuel cell stack are operated at a different pressure level. If no air humidifier is provided in the second air feed line branch, the water vapor tapped off from the air dehumidifier can be passed directly into the second air feed line branch, where it mixes with the air stream there. If an air humidifier is provided in the second air feed line branch, the line can lead to the air humidifier, by means of which the air stream in the second air feed line branch is humidified.

According to a particularly preferred development of the invention, provision can be made in the hybrid system for an open-loop control unit to be provided for open-loop control of the compressor or a closed-loop control unit to be provided for closed-loop control of the compressor. The open-loop control unit allows the air stream drawn in to be compressed by different amounts in the air feed line. That is to say, the pressure in the air stream can be increased or reduced through appropriate activation of the compressor. The open-loop control unit advantageously allows the air stream to be metered selectively. However, a closed-loop control unit for closed-loop control of the compressor is particularly preferred. The voltage of the metal/air battery can be used as the controlled variable, for example. If there is a change in the voltage of the metal/air battery, the closed-loop control unit can activate the compressor and thereby increase or reduce the pressure of the air stream in the air feed line as a function of the measured voltage at the metal/air battery. This allows optimum metering of the air supply to the hybrid system, in particular the metal/air battery. As a result, the efficiency of the hybrid system, in particular that of the metal/air battery, can be increased. Through appropriate activation of the air compressor, the air or oxygen supply to the metal/air battery and the fuel cell stack can be adapted to the required power of the hybrid system without the air compressor consuming any unnecessary parasitic power. In addition, the pressure level can be adapted if this is advantageous for the air or oxygen supply to the metal/air battery.

The open-loop control unit or the closed-loop control unit can furthermore be designed in such a way that any throttle elements or air humidifiers or air dehumidifiers present in the hybrid system can likewise be subjected to open-loop or closed-loop control.

In addition, at least one filter element can be provided in the air feed line in order to clean the air drawn in.

According to the second aspect of the invention, the object is achieved by a method for supplying air to a hybrid system having at least one metal/air battery and at least one fuel cell stack, the method being characterized by the following method steps:
a) air for supplying air to the at least one metal/air battery and to the at least one fuel cell stack is sucked into an air feed line of a common air supply device,
b) the air stream in the air feed line is compressed by a compressor,
c) the air stream is divided into a first air stream and into a second air stream and
d) the first air stream is fed to the at least one metal/air battery and the second air stream is fed to the at least one fuel cell stack.

To supply air or oxygen to the at least one metal/air battery and to the at least one fuel cell stack, air, in particular ambient air, is first of all drawn into the air feed line of the air supply device or sucked in via an appropriate intake device, such as a fan. The air stream sucked in is then compressed by a compressor in the air feed line. It is advantageous if the air stream is compressed to a pressure of between 1.1 and 4 bar, in particular to 3 bar or approximately 3 bar. The compressed air stream is divided into a first air stream and a second air stream. This means that a division or branch in the air feed line divides the air stream into a first air feed line branch and a second air feed line branch. The first air feed line branch leads to the metal/air battery, and the second air feed line branch leads to the fuel cell stack. Such a method makes it possible to supply compressed air both to the at least one metal/air battery and to the at least one fuel cell stack of a hybrid system by means of a single intake device, a single air feed line and a single compressor. This cuts down the number of construction elements and the production costs of the hybrid system since there is no need to provide two separate air supply systems, each with an intake device, an air feed line and a compressor.

According to a preferred development of the invention, provision can be made in the method for the pressure of the first air stream ahead of the inlet line leading to the at least one metal/air battery, i.e. in the first air feed line branch, and/or the pressure of the second air stream ahead of the inlet line leading to the at least one fuel cell stack, i.e. in the second air feed line branch, to be throttled. If the metal/air battery and the fuel cell stack are not designed for the same air pressure level, it is necessary to reduce the pressure in one of the inlet lines, i.e. in one air feed line branch. The pressure in one of the inlet lines can be reduced by means of a throttle element, e.g. a nozzle, a valve or a throttle flap. If a throttle element is provided in each of the two air feed line branches, it is possible to reduce either the air pressure for the metal/air battery or the air pressure for the fuel cell stack, depending on requirements.

Another preferred method is one in which, after the air stream in the air feed line has been compressed by a compressor, the air stream is cooled by at least one cooling device, e.g. a heat exchanger, in particular an air heat exchanger. The temperature of the air stream increases to a greater or lesser degree, depending on the extent to which the air stream drawn in is compressed by the compressor. At a compression of up to 3 bar, the air stream can be heated up to 150° C., for example. Since the fuel cell stack is preferably operated at a temperature of between 60° C. and 70° C., it is necessary to cool the air stream at an air pressure of 3 bar. The same applies to the metal/air battery. The metal/air battery is preferably operated at an air pressure of 3 bar with an air stream which has a temperature of between 40° C. and 50° C. For this purpose, further cooling of the air stream for the metal/air battery may be required. This can be accomplished either by the division of the air stream into two air feed line branches taking place in the cooling device, with the first air feed line branch, which leads to the metal/air battery, being passed through the cooling device over a longer distance, ensuring that the air stream in this first air feed line branch is cooled more intensively. As an alternative, the air stream in the first air feed line branch can be cooled by means of a further cooling device, in particular a further heat exchanger, which is provided in addition in the first air feed line branch.

According to another preferred development of the invention, provision can be made in the method for the first air stream to be dehumidified ahead of the inlet line leading to the at least one metal/air battery, and/or for the second air stream to be humidified ahead of the inlet line leading to the at least one fuel cell stack. In other words, it may be necessary, depending on the construction of the fuel cell stack, for the compressed air fed to the fuel cell stack to be additionally humidified. This can be accomplished by means of an air humidifier, which is arranged in or on the second air feed line branch. As an alternative or in addition, provision can be made for the compressed air stream for the metal/air battery to be dehumidified if the metal/air battery does not tolerate any air humidity. This can be accomplished, for example, by means of an air dehumidifier arranged in or on the first air feed line branch. It is particularly preferred if the water vapor removed from the first air stream is used to humidify the second air stream. In other words, the water vapor removed from the first air stream can be fed to the second air stream, i.e. the air stream in the second air feed line branch, via a line connecting the first air feed line branch to the second air feed line branch. In this arrangement, it is advantageous if the line connects the air dehumidifier in the first air feed line branch to the air humidifier in the second air feed line branch.

According to a particularly preferred development of the invention, provision can furthermore be made in the method for the compressor to be subjected to open-loop control by an open-loop control unit or to closed-loop control by a closed-loop control unit. This allows optimum metering of the air supply to the hybrid system. The compression pressure can be greater or less, depending on requirements. Thus, the compressor can be activated by means of an open-loop control unit, and time-controlled compression of the air stream can be provided. If, for example, provision is made for the hybrid system to produce a different power after a predetermined time, this can be accomplished through appropriate activation of the compressor. It is particularly preferred for the compressor to be activated by a closed-loop control unit. In other words, a certain controlled variable of the hybrid system, e.g. the voltage of the metal/air battery and/or the fuel cell voltage, can thus be used for closed-loop control of the compressor, for example. If, for example, an increase in the voltage of the metal/air battery is detected, the compressor can be activated in such a way by the closed-loop control unit that it compresses the air stream to a lesser extent. If a drop in the voltage of the metal/air battery is detected, on the other hand, the closed-loop control unit can make the compressor compress the air stream drawn in to a greater extent, on the basis of the detected voltage of the metal/air battery. Furthermore, the open-loop control unit or the closed-loop control unit can also be designed for activation of any throttle elements or air humidifiers or air dehumidifiers present. This makes it possible, for example, for the hybrid system to output a constant power automatically. The open-loop control unit or the closed-loop control unit allows optimum metering of the air supply to the hybrid system, in particular to the metal/air battery. In particular, the efficiency of the hybrid system, in particular of the metal/air battery, can be increased by selective compressed air supply.

### BRIEF DESCRIPTION OF THE DRAWINGS

Further advantages, features and details of the invention will become apparent from the following description, in which various illustrative embodiments of the invention are described in detail with reference to the drawings. In this connection, the features mentioned in the claims and in the description may each be essential to the invention individually per se or in any combination. In the drawings:

FIG. 1 shows a block diagram of a first hybrid system, which is constructed in accordance with the design principle according to the invention,

FIG. 2 shows a block diagram of a second hybrid system, which is constructed in accordance with the design principle according to the invention,

FIG. 3 shows a block diagram of a third hybrid system, which is constructed in accordance with the design principle according to the invention, and

FIG. 4 shows a block diagram of a fourth hybrid system, which is constructed in accordance with the design principle according to the invention.

### DETAILED DESCRIPTION

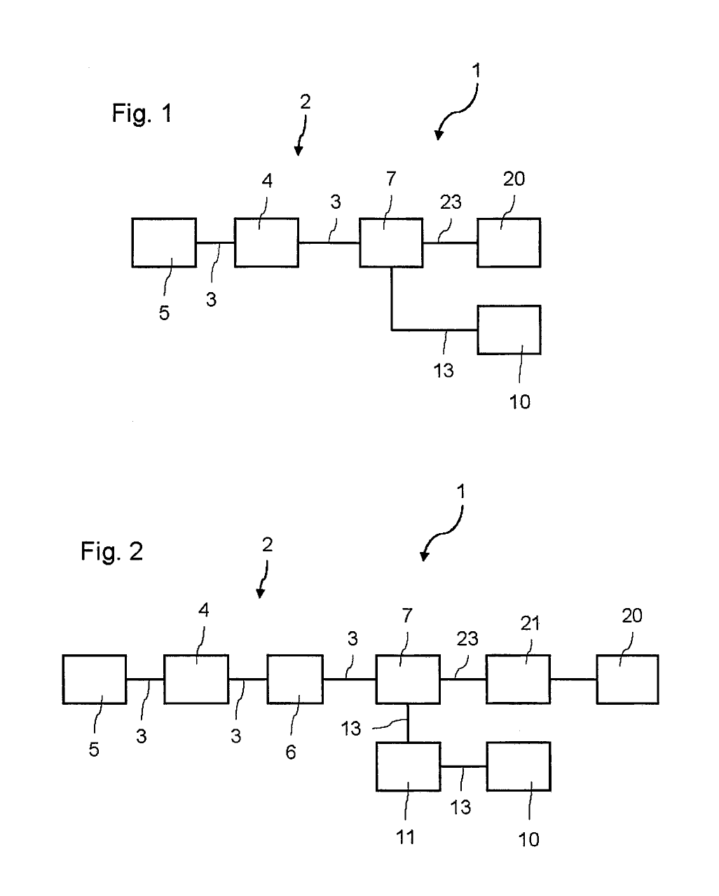

In FIGS. 1 to 4, elements with the same function and mode of operation are each provided with the same reference signs.

FIGS. 1 to 4 show various hybrid systems 1, which are designed in accordance with the design principle according to the invention, in the form of block diagrams.

FIG. 1 shows a hybrid system 1 which has a metal/air battery 10 and a fuel cell stack 20. The hybrid system 1 has a common air supply device 2. The air supply device 2 has an intake device 5, an air feed line 3 and a compressor 4. The intake device 5, e.g. a fan, sucks air, in particular ambient air, into the air feed line 3. In the air feed line 3, the air or air stream drawn in is compressed by a compressor 4. It is advantageous to compress the air stream by as much as 3 bar. Provided downstream of the compressor 4 is a branch 7, which divides the compressed air stream. In the first air feed line branch 13, a first air stream is fed to the metal/air battery 10, in particular to the cathode or air electrode of the metal/air battery 10. In the second air feed line branch 23, a second air stream is fed to the fuel cell stack 20, in particular to the cathode side of the fuel cell stack 20. In addition, provision can be made for a filter element for cleaning the air stream drawn in to be arranged in the air feed line 3.

A hybrid system 1 of this kind makes the hybrid system 1, especially the air supply device 2, compact in construction. Both the metal/air battery 10 and the fuel cell stack 20 are supplied with compressed air by means of a single air supply device 2, i.e. just one intake device 5, one air feed line 3 and just one compressor 4. In addition to the more compact construction, this makes it possible to save costs in the production of the hybrid system 1.

In comparison with the first hybrid system 1 in accordance with FIG. 1, a cooling device 6 is additionally connected to the outlet of the compressor 4 in the second illustrative embodiment of the hybrid system 1. Since the compression of the air stream by the compressor 4 heats up the air stream, in particular to a temperature of up to 150° C., it may be necessary for the compressed and heated air stream to be cooled. The fuel cell stack 20 and the metal/air battery 10 are preferably each supplied with a compressed air stream which is at an air temperature of 40° C. −70° C. In the second variant embodiment of the hybrid system 1, throttle elements 11, 21 are furthermore provided in the respective air feed line branches 13, 23. These throttle elements 11, 21 make it possible to reduce the pressure of at least one of the air streams if the metal/air battery 10 and the fuel cell stack 20 are not designed for the same pressure level. Preference is given to a variant embodiment of the hybrid system 1 in which a throttle element 11 is provided only in the first air feed line branch 13. This is provided especially when the metal/air battery 10 requires a lower air pressure level than the fuel cell stack 20. If the fuel cell stack 20 has the lower pressure level, a throttle element can preferably be provided only in the second air feed line branch 23.

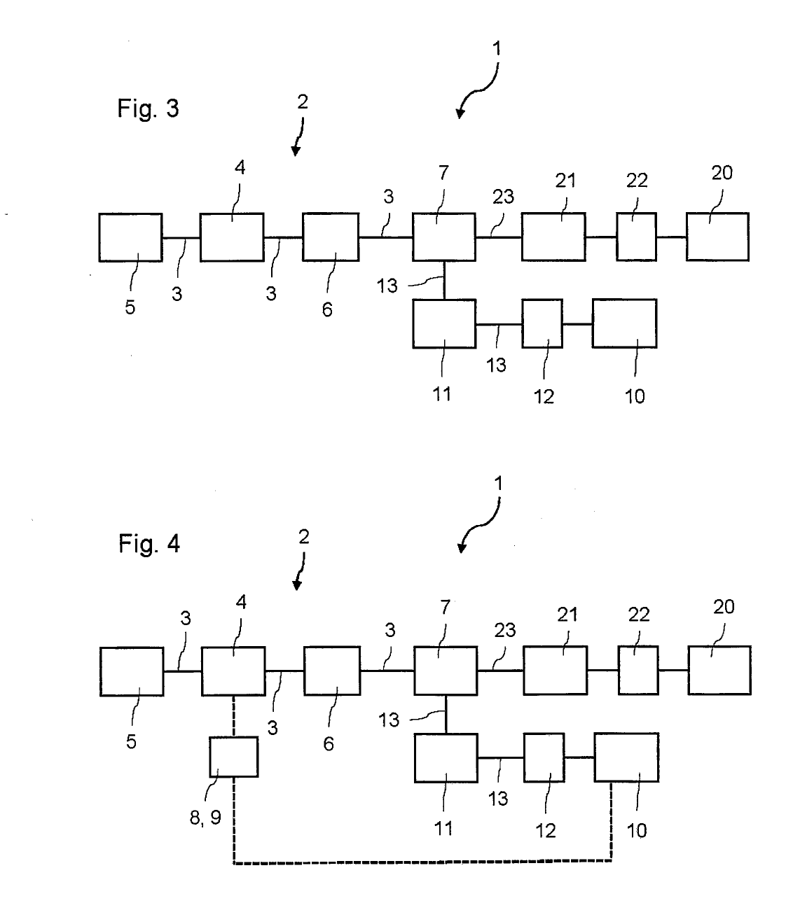

FIG. 3 shows a third variant embodiment of the hybrid system 1 according to the invention. This variant embodiment of the hybrid system 1 differs from the second variant embodiment of the hybrid system 1 in accordance with FIG. 2 in that an air dehumidifier 12 is additionally provided in the first air feed line branch 13, and an air humidifier 22 is additionally provided in the second air feed line branch 23. In the hybrid system 1, it is possible for both an air dehumidifier 12 to be provided in the first air feed line branch 13 leading to the metal/air battery 10 and to provide an air humidifier 22 in the second air feed line branch 23 leading to the fuel cell stack 20. As an alternative, it is possible to provide either an air dehumidifier 12 in the first air feed line branch 13 leading to the metal/air battery 10 or an air humidifier 22 in the second air feed line branch 23 leading to the fuel cell stack 20 in the hybrid system 1. An air dehumidifier 12 in the inlet line, i.e. in the first air feed line branch 13, leading to the metal/air battery 10 is required when the metal/air battery 10 does not tolerate any air humidity. For this purpose, the moisture must be removed from the air stream fed to the metal/air battery 10. The air stream conditioned, i.e. dehumidified, in this way is passed into the air electrode of the metal/air battery 10. The air stream fed to the fuel cell stack 20 may furthermore still require humidification. This is accomplished by means of the air humidifier 22 in the second air feed line branch 23. The air dehumidifier 12 and the air humidifier 22 can advantageously be connected to one another by way of a line, thus allowing the moisture removed from the air stream for the metal/air battery 10, in particular the water vapor removed, to be fed to the air humidifier 22 in the second air feed line branch 23. This advantageously eliminates the need for an additional external water vapor feed.

FIG. 4 shows a fourth variant embodiment of the hybrid system 1 according to the invention. As an addition to the variant embodiment of the hybrid system 1 in accordance with FIG. 3, the fourth variant embodiment of the hybrid system 1 in accordance with FIG. 4 has a closed-loop control unit 9 or an open-loop control unit 8. By means of the open-loop control unit 8, the compressor 4 can be subjected to open-loop control. The open-loop control unit 8 makes it possible to vary the compression of the air stream drawn in the air feed line 3. That is to say, the air stream can be compressed to a greater or lesser extent by means of appropriate activation of the compressor 4. The open-loop control unit 8 enables the air stream to be metered selectively. It is particularly preferable to provide a closed-loop control unit 9 for closed-loop control of the compressor 4 instead of the open-loop control unit 8. The voltage of the metal/air battery 10 and/or of the fuel cell stack 20 can be used as the controlled variable, for example. When there is a change in the voltage of the metal/air battery 10, the closed-loop control unit 9 can activate the compressor 4 accordingly and thereby increase or reduce the pressure of the air stream in the air feed line 3. This allows optimum metering of the air or oxygen supply to the hybrid system 1, in particular of the metal/air battery 10. It is thereby possible to increase the efficiency of the hybrid system 1, in particular that of the metal/air battery 10. Through selective activation of the compressor 4 by the open-loop control unit 8 or the closed-loop control unit 9, the compressed air supply to the at least one metal/air battery 10 and to the at least one fuel cell stack 20 can be adapted to the required power of the hybrid system 1, thus ensuring that the compressor 4 does not consume any unnecessary parasitic power. In addition, the pressure level can be adapted if this is advantageous for the air supply or oxygen supply, especially to the metal/air battery 10.

The connections of the metal/air battery 10 to the closed-loop control unit 9 or to the open-loop control unit 8 and between the closed-loop control unit 9 or the open-loop control unit 8 and the compressor 4 are represented by the dashed lines.

1. A hybrid system (1) having at least one metal/air battery (10) and at least one fuel cell stack (20), characterized in that the hybrid system (1) has an air supply device (2) with an air feed line (3), an intake device (5) and a compressor (4) for compressing the air stream in the air feed line (3), the air supply device (2) supplying air to the at least one metal/air battery (10) and supplying air to the at least one fuel cell stack (20) with an air stream subjected to excess pressure.

2. A hybrid system (1) according to claim 1, characterized in that at least one cooling device (6) for cooling the compressed air stream downstream of the compressor (4) is arranged in or on the air feed line (3).

3. A hybrid system (1) according to claim 2, characterized in that the air feed line (3) is divided into two air feed line branches (13, 23) in or after the cooling device (6), a first air feed line branch (13) feeding air to the at least one metal/air battery (10), and a second air feed line branch (23) feeding air to the at least one fuel cell stack (20).

4. A hybrid system (1) according to claim 3, characterized in that a throttle element (11, 21) for reducing the pressure of the air stream is provided in the first air feed line branch (13) and/or in the second air feed line branch (23).

5. A hybrid system (1) according to claim 3, characterized in that an air dehumidifier (12) is provided in the first air feed line branch (13) and/or an air humidifier (22) is provided in the second air feed line branch (23).

6. A hybrid system (1) according to claim 5, characterized in that an air dehumidifier (12) in the first air feed line branch (13) is connected to the second air feed line branch (23) or to an air humidifier (22) in the second air feed line branch (23) for the purpose of humidifying the air stream in the second air feed line branch (23).

7. A hybrid system (1) according to claim 1, characterized in that an open-loop control unit (8) is provided for open-loop control of the compressor (4) or a closed-loop control unit (9) is provided for closed-loop control of the compressor (4).

8. A method for supplying air to a hybrid system (1) having at least one metal/air battery (10) and at least one fuel cell stack (20), comprising:
a) air for supplying air to the at least one metal/air battery (10) and to the at least one fuel cell stack (20) is sucked into an air feed line (3) of a common air supply device (2);
b) the air stream in the air feed line (3) is compressed by a compressor (4);
c) the air stream is divided into a first air stream and into a second air stream; and
d) the first air stream is fed to the at least one metal/air battery (10) and the second air stream is fed to the at least one fuel cell stack (20).

9. A method according to claim 8, characterized in that the pressure of the first air stream ahead of the inlet line leading to the at least one metal/air battery (10) and/or the pressure of the second air stream ahead of the inlet line leading to the at least one fuel cell stack (20) is throttled.

10. A method according to claim 8, characterized in that, after the air stream in the air feed line (3) has been compressed by a compressor (4), the air stream is cooled by at least one cooling device (6).

11. A method according to claim 8, characterized in that the first air stream is dehumidified ahead of the inlet line leading to the at least one metal/air battery (10), and/or the second air stream is humidified ahead of the inlet line leading to the at least one fuel cell stack (20).

12. A method according to claim 11, characterized in that the water vapor removed from the first air stream is used to humidify the second air stream.

13. A method according to claim 8, characterized in that the compressor (4) is subjected to open-loop control by an open-loop control unit (8) or to closed-loop control by a closed-loop control unit (9).
